(19) United States
(12) Patent Application Publication
(10) Pub. No.: US 2006/0044812 A1
(43) Pub. Date: Mar. 2, 2006

(54) Illumination device for religious observance

(75) Inventors: Michael Dutka, Mechanicsville, PA (US); Philip Salkie, Metuchen, NJ (US)

Correspondence Address: THE PATENT LAW OFFICE OF FRANK P. BECKING, P. O. BOX 800, PALO ALTO, CA, 94302, US

(73) Assignee: Michael Dutka, Mechanicsville, PA (US)

(21) Appl. No.: 11/112,728

(22) Filed: Apr. 23, 2005

Related U.S. Application Data
(63) Continuation of application No. 09/920,419, filed on Aug. 1, 2001, now abandoned.

(51) Int. Cl. F21V 19/00; F21V 21/00

(52) U.S. Cl. 362/382

(57) ABSTRACT

An illumination device that includes at least two concentrically mounted cylinders Mounted within the narrower cylinder is at least one light source. The cylinders are mounted such that at least one of the cylinders may be selectively rotated, by a user, about the common axis of concentricity relative to the other cylinder. Each of the cylinders further includes sections which extend along the long axis thereof, at least one of which is completely opaque and at least one of which is either semi-translucent, completely translucent, or entirely transparent. The sections of various opacities are sufficiently and appropriately sized such that, by corresponding alignments thereof, by the selective relative rotation of the cylinders, the light source within the nested cylinders may alternatively provide illumination, or be effectively covered without requiring the active turning on or off of the light source.

### BACKGROUND OF THE INVENTION

1. Field of the Invention

This invention relates generally to illumination devices and/or lamps which are usable in certain religious observances, and more particularly to electric lamps which are usable by observant Jews during certain significant religious periods such as Shabbos.

2. Description of the Prior Art

Within the field of religious lighting, a wide variety of devices have been developed to meet the various specific design criteria which relate to the certain ceremonial and/or restrictive tenets of the religion. Examples of these include candle holders for Hannukah and Christmas (see U.S. Pat. No. 6,047,407 to Habel).

In particular, with respect to the present invention, the Jewish religion proscribes against the kindling or extinguishing of light or electricity on Shabbos (the Sabbath, which begins just before sunset each Friday evening, and ends just after sunset each Saturday evening). This restriction presents a unique set of problems for strict observers of these rules. Specifically, if the individual chooses to turn on a light prior to sunset on Friday evening, the light must remain on for the entire night. These lights can often interfere with sleep and/or the normal activities of the family which lives in the home. One pattern of behavior in response to this inconvenience has been to place an opaque object over the light. This act can be very risky inasmuch as it is often a fire risk. Alternatively, the lights may be moved into another room which may then be avoided. This requires either long extension cords or battery operated lanterns. However, the strictest interpretations of religious rules forbid this practice, or even the touching of a lamp or other light source. Finally, a wide variety of electric timing devices have been used in connection with this restriction, and are generally accepted in religious interpretation and current practice. These devices, often referred to as ‘Shabbos Clocks,’ are preset before Shabbos to turn lights on and off during Shabbos, based on users' anticipated needs. However, they allow users no flexibility during Shabbos to deal with common, but not specifically anticipated occurrences, such as a dinner party that continues past the time the devices are set to turn off dining room lights, or the need to feed or attend to a baby in an unlit bedroom in the middle of the night. None of these alternatives provides an ideal solution to the difficulty presented by the religious proscriptions.

A device disclosed in U.S. Pat. No. 4,809,145 to Bennet purports to address these limitations. However, the device is merely an opaque to translucent shade that covers the light source and the device as claimed requires that the shade have means for the escape of heat. Unfortunately, this configuration acknowledges that the buildup of heat is a problem for the device and that a fire risk is presented even when the shade has a means for the escape of heat. That is, the device has no other fire risk prevention design feature. Further, the disclosed means for the escape of heat includes holes for ventilation, and such holes would necessarily allow light to pass through, thereby causing the device to fall short of its goal of being able to fully block the light from the light source. In addition, the light in this device is either fully blocked by an opaque shade (or dimmed by a translucent shade) or fully unrestricted, and therefore the device cannot be used to selectively vary the light restriction. This limits its usefulness.

It is, therefore, an object of the present invention to provide an illumination device which may selectively provide illumination or not, without requiring the kindling or extinguishing of light or electricity.

It is further an object of the present invention to provide an illumination device which may selectively provide illumination or not, without requiring the kindling or extinguishing of light or electricity, and which can be used to vary the amount and direction of the light that is permitted to escape.

It is further an object of the present invention to provide an illumination device which may selectively provide illumination, without requiring the kindling or extinguishing of light or electricity, and which has design features that limit a fire risk that do not compromise its ability to completely block the light.

It is further an object of the present invention to provide an illumination device which may selectively provide illumination, without requiring the kindling or extinguishing of light or electricity, and which does not require the movement of the lighting device to another area.

It is further an object of the present invention to provide an illumination device which may selectively provide illumination, without requiring the kindling or extinguishing of light or electricity, and which does not require the user to touch, or come into any physical contact with the light source itself.

Other objects, not explicitly described here, shall be set forth with respect to the descriptions and illustrations provided hereinafter.

### SUMMARY OF THE INVENTION

The preceding objects are provided for by the present invention, which comprises new and novel illumination devices. As will be set forth in more detail hereinbelow, with respect to specific embodiments, the present invention comprises an illumination device having a light source which may be left on for an arbitrary length of time, but which may be operated such that it provides illumination only to the region around it when selectively disposed to do so. Alternatively, the present invention may be manipulated with minimal effort to eliminate most or all illumination without requiring that the light source itself be extinguished, or even touched.

A preferred embodiment of the illumination device includes a pair of shuttering elements which are disposed adjacent to a light source. Each of the shuttering, or screening members have at least one portion thereof which is opaque and at least one other portion thereof which is translucent. At least one of the two screening members is mounted such that it is selectively translateable relative to the other such that the translucent portions and opaque portions of both screening members may be, alternatively, aligned. When the translucent portions are aligned, the light from the light source can pass through said screening members and illuminate the area in front of the screens. Correspondingly, when the screens are moved into a position such that the opaque portions cover the entire area in front of the light, light from the light source may not pass through said screening members, despite the fact that the light source remains powered.

More particularly, the preferred embodiment has a first element with a stable base and an upwardly extending mounting arm from which extends a light source (preferably, a U-shaped fluorescent bulb, also referred to in some cases as a compact fluorescent bulb), parallel to the base. Fluorescent bulbs are not essential aspects of, but rather are merely preferred for use with, all embodiments described as they generate the least heat, and therefore present the least possibility of discomfort or burn injury from touching said embodiments, and the least risk of fire. The preferred embodiment further has a second element with a stable base, two upwardly extending support arms, and an enclosure defined by inner and outer concentric cylinder members extending between the support arms parallel to the base. An aperture in one of the support arms leads to the enclosure. When the bases are brought together, the light source fits through the aperture and within the enclosure, without touching the inner cylinder. The cylindrical members are formed such that a portion of each is opaque and a portion is translucent. Ideally, the portions of each which are translucent form axially extending sections which encompass less than half of the total circumference of the corresponding cylinder. The cylinders are mounted to the upwardly extending mounting arms in such a manner that at least one of the cylinders may be rotated relative to the other about the shared cylindrical axis. Selective adjustment of the cylinders' relative disposition, therefore, allows the opaque portions to entirely block the light. Alternatively, the translucent portions may be aligned to permit the light to shine through the cylinders and illuminate the region around the device. During these operations, no portions of the first element come into physical contact with the second element. In this manner, the second element can be used to effectively block the light while the light source remains lit, and without physically interacting with the first element. Therefore, the lamp may be deemed suitable for use with religious observance requirements such as those related to Shabbos.

Another embodiment of the present invention integrates the first and second elements of the preferred embodiment into a single element having one or more lights sources extending from one or both support arms into the cylindrical enclosure, which is preferably structurally and functionally identical to that of the second element of the preferred embodiment. This other embodiment has a stable base, and a pair of upwardly extending mounting arms. Disposed between the mounting arms are inner and outer concentric cylindrical members that form an enclosure. Within the enclosure is a light source (preferably a slender or U-shaped fluorescent bulb, also referred to in some cases as a compact fluorescent bulb), electrically coupled to a socket formed on one or both of the upwardly extending mounting arms. The cylindrical members are formed such that a portion of each is opaque and a portion is translucent. Ideally, the portions of each which are translucent form axially extending sections which encompass less than half of the total circumference of the corresponding cylinder. The cylinders are mounted to the upwardly extending mounting arms in such a manner that at least one of the cylinders may be rotated relative to the other about the shared cylindrical axis. Selective adjustment of the cylinders' relative disposition, therefore, allows the opaque portions to entirely block the light. Alternatively, the translucent portions may be aligned to permit the light to shine through the cylinders and illuminate the region around the device. During these operations, the cylinders do not physically interact with the light source.

Other embodiments include vertically aligned light sources and/or screening members. For example, yet another embodiment of the invention includes screening members as a pair of concentric domes which nest on a base unit having a socket with a vertically-aligned light source. As with the embodiments described above, portions of each of the screening domes are translucent, while others are opaque. Alignment of the domes such that translucent regions are coincident provides for illumination. Conversely, alignment of the domes such that there are no coincident translucent portions provides for complete darkness.

With regard to other examples of embodiments with vertically aligned light sources and/or screening members, additional embodiments of the invention include an inner vertically aligned translucent cylinder as a first screening member enveloping a vertically-aligned light source, and an outer opaque cylinder as a second screening member. Each of the embodiments disclosed contemplate a different form of a vertically-aligned outer cylinder. In one, the outer cylinder is a solid cylinder that fits over the inner cylinder and into a slot at the base supporting the inner cylinder. This cylinder can be so placed to block light from the light source, or removed to allow light to escape. In another, the outer cylinder is formed by a two semi-cylindrical panels, at least one of which can move with respect to the other along a circumferential track in the base supporting the inner cylinder. The panels can be positioned to envelop the inner cylinder to completely block light from the light source, or can be positioned in a number of positions that expose a portion of the inner cylinder to allow light to escape. In yet another, the outer cylinder is formed by a folding sliding door that opens and closes along a circumferential track in the base supporting the inner cylinder. Moving ends of the door together causes the inner cylinder to be enveloped, thereby blocking light from the light source. Moving the ends apart exposes the inner cylinder, allowing light to escape. In each of these embodiments, the shading mechanism does not touch the light source, and does not require the light source to be extinguished or lit in order to regulate the illumination provided. Further in each of these latter two embodiments, a second, translucent, outer cylinder (covering the first outer cylinder) can be provided to effectively enclose the first outer cylinder between two cylinders (the inner cylinder and the second outer cylinder). This could protect the open and closure mechanism of the first outer cylinder from dirt or damage, and provide additional conformance to religious requirements, inasmuch as the strictest interpretations of relevant Jewish law require that the opening and closing of enclosing elements be minimized or avoided.

It shall be understood that the term “opaque” when used herein refers to being impenetrable by light, the term “translucent” when used herein refers to transmitting light but causing diffusion of the light, and the term “transparent” when used herein refers to being capable of transmitting light so that objects or images can be seen as if there were no intervening material. It shall be understood that in alternative embodiments, or subtle but obvious modifications of the present invention, the translucent portions may be fully transparent and the opaque portions may be incompletely opaque. For example, some of these portions may be semi-opaque, polarized glass, colored glass, or other form of glass which interrupts the complete transmission of the light from within the device. Various designs, shapes, and geometric orientations of the opaque and translucent regions are also contemplated, but are viewed simply as artistic variations of the same principles which are embodied in this invention. It should also be understood that in certain embodiments where cylinders are used as screening members and do not require rotation of elements, other geometric shapes are suitable, such as cubes or rectangular boxes. It should also be understood that the present invention encompasses embodiments that are structurally similar to the embodiments disclosed, but instead of moving panels or folding doors, employ various other screening elements that are suitable for regulating the transmission of light, such as solid or flexible curtains that lower and/or raise, fold inward and/or outward, and/or that operate like venetian blinds. It should also be understood that although the embodiments discussed herein are described for use with a single bulb as a light source, the invention contemplates embodiments where multiple bulbs or other elements are used as a light source of the invention. It should also be understood that certain embodiments may be acceptable for use according to certain religious law interpretations, but not others, and therefore that the embodiments can be modified as required to permit adherence to more strict or less strict interpretations as needed. Finally, it should also be understood that although the invention herein is described for use with religious requirements, the invention can be used in other applications, including, but not limited to camping, use with full-spectrum light bulbs, and the management of light sources in commercial, industrial and other applications that require extended time and energy to initially illuminate the light source.

### BRIEF DESCRIPTION OF THE DRAWINGS

FIG. 1a is a perspective view of a first element of a preferred embodiment of the present invention.

FIG. 1b is a perspective view of a second element of the preferred embodiment.

FIG. 2a is a side view of concentric cylinders of the second element shown in FIG. 1b,

FIG. 2b is a cutaway view of the concentric cylinders of FIGS. 1b and 2a, showing how the cylinders fit onto a mounting cylinder on a support arm of the second element of the preferred embodiment.

FIG. 2c is a cutaway perspective view of the concentric cylinders of FIGS. 1b, 2a and 2b, showing control rods for rotating the cylinders.

FIG. 3 is a perspective view of another embodiment of the present invention showing a base with support arms and concentric cylinders extending therebetween and enveloping a light source.

FIG. 4 is a perspective view of yet another embodiment of the present invention showing rotatable domes enveloping a vertically-aligned light source.

FIGS. 5a-c show still another embodiment of the present invention, with FIG. 5a showing an elevation view of a first element with a base supporting a vertically-aligned light source, FIGS. 5b-c showing elevation views of a second element having an inner cylinder on a base that fully envelopes the base of the first element and having outer cylinder that envelopes the inner cylinder and fits into a slot in the base of the second element.

FIGS. 6a-d illustrate still another embodiment of the present invention, with FIG. 6a-b showing elevation and top views, respectively, of a second element of the embodiment with panels of an outer cylinder open to reveal an inner cylinder, and FIGS. 6c-d showing elevation and top views, respectively, of the second element with the panels closed to envelope the inner cylinder.

FIGS. 7a-b illustrate still another embodiment of the present invention, with FIG. 7a showing a top view of a second element with a folding door of an outer cylinder open to reveal an inner cylinder, and FIG. 7b showing a top view of the second element with the folding sliding door closed to envelope the inner cylinder.

FIG. 7c illustrates still another embodiment of the present invention, showing a second outer cylinder covering the first outer cylinder of the embodiment of FIGS. 7a-b to enclose the first outer cylinder between the inner cylinder and the second outer cylinder.

### DETAILED DESCRIPTION OF THE PREFERRED EMBODIMENT

While the present invention will be described more fully hereinafter with reference to the accompanying drawings, in which particular embodiments are shown, it is to be understood at the outset that persons skilled in the art may modify the invention herein described while achieving the functions and results of this invention. Accordingly, the descriptions which follow are to be understood as illustrative and exemplary of specific structures, aspects and features within the broad scope of the present invention and not as limiting of such broad scope.

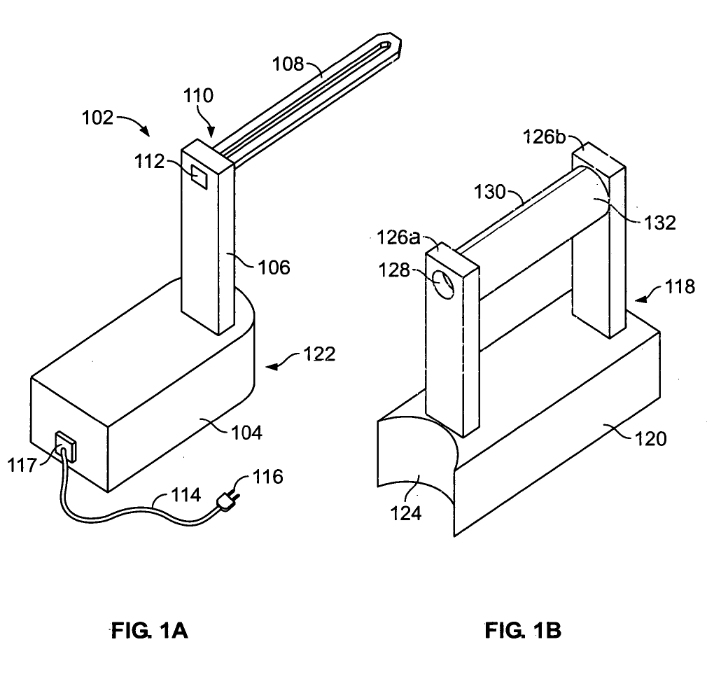

Referring specifically to the embodiment illustrated in FIGS. 1a-b, a preferred embodiment of the present invention is shown in a disassembled view to clearly illustrate two cooperating elements of the embodiment. It should be understood that the outset that more than two elements can be used to achieve the described functionality, and the invention is not limited to the use of a particular number of elements of any embodiment described herein.

The first element 102 supports a light source 108, and the second element 118 supports at least one shield 130,132 that can be made to envelop the light source 108 when the elements 102,118 are brought together. Inasmuch as the shields 130,132 are concentric and each has at least one opaque portion and at least one translucent (or transparent) portion, rotation of the shields 130,132 with respect to one another can either block the light from the light source 108, or reveal the light when the light source 108 is enveloped. Inasmuch as the first element 102 and the second element 118 need not touch during this operation, the embodiment, as with all embodiments described herein, may be deemed suitable for use with religious observance requirements such as those related to Shabbos.

The first element 102, shown in FIG. 1a, includes a base 104, which should be a stable and solid structural element, and a mounting arm 106 extending upwardly from a top surface of the base 104. The light source 108 extends from the mounting arm 106, preferably parallel to the base 104 as shown. The light source 108 in this embodiment is electrically connected to a socket 110 formed on the mounting arm 106. Preferably, as shown, an opening hatch 112 formed on the mounting arm 106 allows the light source 108 to be inserted directly into the socket 110 housed inside the hatch 112, which is in turn, connected to a ballast (or functionally equivalent element) housed in the first element 102. The opening hatch 112 also allows users to extract the light source 108 for replacement. Alternately, light source 108 can be inserted directly into the socket 110, obviating the need for the hatch 112. The electrical connection in this embodiment is provided by a cord 114 with a standard electric plug 116 that can be inserted into a wall outlet, and an on/off switch 117 that regulates the provision of electricity to the light source 108.

It should be understood that other electrical connections are contemplated, including, but not limited to, an electrical connection between the socket 110 and a battery. In this manner, the present invention provides for portable embodiments. It should be understood that all embodiments discussed herein can be adapted for use as portable or permanent illumination devices, and the provision of power to the light sources described herein can be accomplished in any known manner, and is not limited to electrical power from wall outlets, or limited to electrical power from batteries.

Preferably in this embodiment and the other embodiments discussed herein, the light source 108 is a low heat bulb, such that even when it is shielded by the shields 130,132 for an extended period of time, the shields 130,132 can be comfortably touched by a bare hand and the risk of fire is minimal. Fluorescent bulbs that are commercially available are suitable in this respect; a slender U-shaped fluorescent bulb of the type shown, referred to in some cases as a compact fluorescent bulb, is preferable. Also preferably, for ease of loading the light source 108 into the socket 110, the light source 108 that is used should not need to be rotated into two opposed ballasts, but rather should simply be insertable into the single ballast housed inside the hatch 112, or even directly into the socket 110.

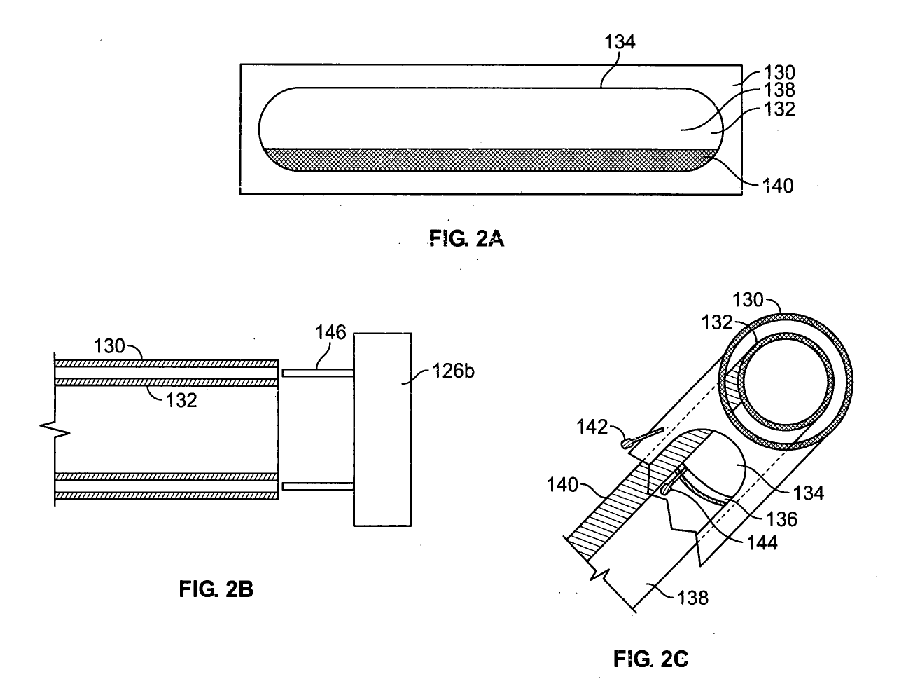

The second element 118, shown in FIG. 1b, includes a base 120 and two support arms 126a, 126b. One of the support arms 126a has an aperture 128 leading to an enclosure defined by the shields 130,132. The shields in this embodiment are outer and inner concentric cylinders 130,132 extending between the support arms 126a,126b. The enclosure is dimensioned to accommodate the light source 108 with room to spare so that no portion of the light source touches the wall of the inner cylinder 132. As best shown in FIGS. 2a-c, the outer cylinder 130 encloses the inner cylinder 132. Referring to FIG. 2b, the concentric cylinders 130,132 can be mounted to the support arms (support arm 126b is shown for example) in that a mounting cylinder 146 is provided on the support arm. The mounting cylinder 146 is dimensioned so that the concentric cylinders 130,132 can be placed on the mounting cylinder 146 with the mounting cylinder 146 passing between the concentric cylinders 130,132. Alternatively, the concentric cylinders 130,132 can be mounted into and rotate around apertures in the support arms 126a,126b.

As shown in FIGS. 2a and 2c, the outer cylinder 130 is opaque except for a translucent (or transparent) strip 134 running approximately ¾ the length of one side and a slot 136 cut along ¼ of its circumference. The inner cylinder 132 also has a translucent (or transparent) portion 138 and an opaque portion 140. Preferably, as shown, the inner cylinder 132 is half opaque and half translucent. The outer cylinder 130 can be rotated by an attached control rod 142. Preferably, as shown, the outer cylinder control rod 142 is mounted just above the translucent strip 134. The inner cylinder 132 can be rotated by an attached control rod 144. Preferably, as shown, the inner cylinder control rod 144 is mounted to pass through the slot 136 in the outer cylinder 130 so that it can be easily accessed. It should be understood that other elements can be used to allow the cylinders to be rotated, and that the described control rods and slot are merely one way in which to achieve this functionality. For example, the support arms can comprise solid towers with apertures in the solid towers of varying diameters around which the outer and inner cylinders rotate.

Referring again to FIGS. 1a-b, the first element base 104 and the second element base 120 preferably interact to assist users in placing the light source 108 within the enclosure. In this embodiment, the interaction is provided by a convex surface 122 on the first element base 104 and a convex surface 124 on the second element base 120. As the bases are brought together in the intended manner to cause the light source 108 to fit within the enclosure, the surfaces 122,124 become flush with one another without touching. It should be understood that other devices and ways can be used to allow the bases to interact. Preferably, gaskets and/or baffles (not shown) are provided around the light source 108 and corresponding reverse gaskets and/or baffles (not shown) are provided in the aperture 128 to prevent light from escaping through the aperture when the light source 108 is within the enclosure.

In operation of this preferred embodiment, the light source 108 would be turned on, for example, before sunset on Friday night. First, the bases 104, 120 would be brought together to make the surfaces 122,124 flush and to cause the light source 108 to fit through the aperture 128 and fully within the enclosure formed by the inner and outer cylinders 130,132. It should be understood that, in accordance with religious observance requirements, the element 108 should not touch the wall of the inner cylinder 108 during use on Shabbos. Thereafter, the plug 116 would be placed into an electrical outlet to provide electricity to the light source 108 and the switch 117 would be turned “on” to cause the light source 108 to generate light.

The cylinders 130,132 can then be rotated as desired and as described below to effect use of the device without violation of religious observance requirements. More particularly, when the translucent portion 138 of the inner cylinder 132 is congruent with the translucent strip 134 of the outer cylinder 130, the light from the light source 108 is revealed. This light can be directed by rotation of the cylinders 130,132 with the control rods 142,144. When the opaque portion 140 of the inner cylinder 132 is congruent with the translucent strip 134 of the outer cylinder 130, the light of the light source 108 is blocked. During these operations, no portions of the first element 102 comes into physical contact with the second element 118. In this manner, the second element can be used to effectively block the light while the light source 108 remains lit, and without physically interacting with the first element 102.

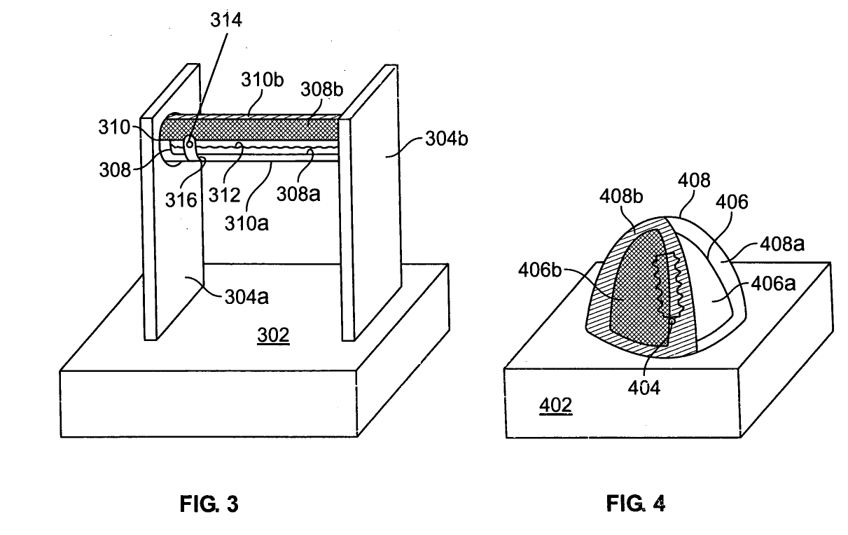

Referring to FIG. 3, another embodiment of the present invention, shown in a perspective view, integrates the first and second elements of the preferred embodiment into a single element having one or more lights sources extending from one or both support arms into the cylindrical enclosure, which is preferably structurally and functionally identical to that of the second element of the preferred embodiment. This other embodiment includes a base 302, which should be a stable and solid structural element. A pair of upwardly extending mounting arms 304a,304b extend from the top surface of the base 302. Disposed at the upper ends 306a,306b of the mounting arms 304a,304b are inner and outer concentric cylindrical members 308,310. Within the inner cylindrical member 308 is a light source 312. Preferably, similarly to the preferred embodiment, this light source 312 is a low heat bulb, for example a slender and/or U-shaped fluorescent bulb, and it is electrically coupled to a socket formed on one, or both, of the upwardly extending mounting arms 340a,304b. The inner and outer concentrically disposed cylindrical members 308,310 are formed such that a portion 308a,310a of each is opaque and a portion 308b,310b is translucent, preferably as described above in the discussion of the preferred embodiment. Preferably, as shown, these portions 308b,310b, each of which are translucent, form axially extending sections which encompass less than half of the total circumference of the corresponding cylinder. The cylinders 308,310 are mounted to the upwardly extending mounting arms 304a,304b in such a manner that at least one of the cylinders may be rotated relative to the other, preferably as described in the discussion of the preferred embodiment. Here, as shown in FIG. 3, the inner cylinder 308 is rotationally mounted to the mounting arms 304a,304b such it may be rotated relative to the outer cylinder 310. More particularly, the inner cylinder 308 comprises a rod 314 which extends through a groove 316 in the outer cylinder 310, thereby permitting a user to rotate the inner cylinder 308. Selective adjustment of the cylinders' relative disposition, therefore, allows the opaque portions to entirely block the light. Alternatively, the translucent portions may be aligned to permit the light to shine through the cylinders and illuminate the region around the device.

While the embodiments discussed above include horizontally oriented light sources and/or one or more horizontally oriented shields, other embodiments can have vertically oriented light sources and/or one or more vertically oriented shields. Accordingly, referring now to FIG. 4, yet another embodiment of the present invention is provided in a perspective view. In this embodiment, a base member 402 includes a socket for receiving a light source 404. Disposed about the light source 404 are a pair of concentric domes 406,408 which nest on the base 402. As with the embodiment of FIG. 3, portions 406a,408a of each of the screening domes are translucent, while other portions 406b,408b are opaque. Alignment of the domes 406,408 such that translucent regions 406a,408a are coincident provides for illumination. Conversely, alignment of the opaque regions 406b,408b such that there are no coincident translucent portions provides for complete darkness. In a preferable embodiment, the base member 402 is disposed around, but not connected to, a light source which it and the other elements described enclose, such that the light source itself is a free-standing element not touched while it is revealed or blocked partially or completely.

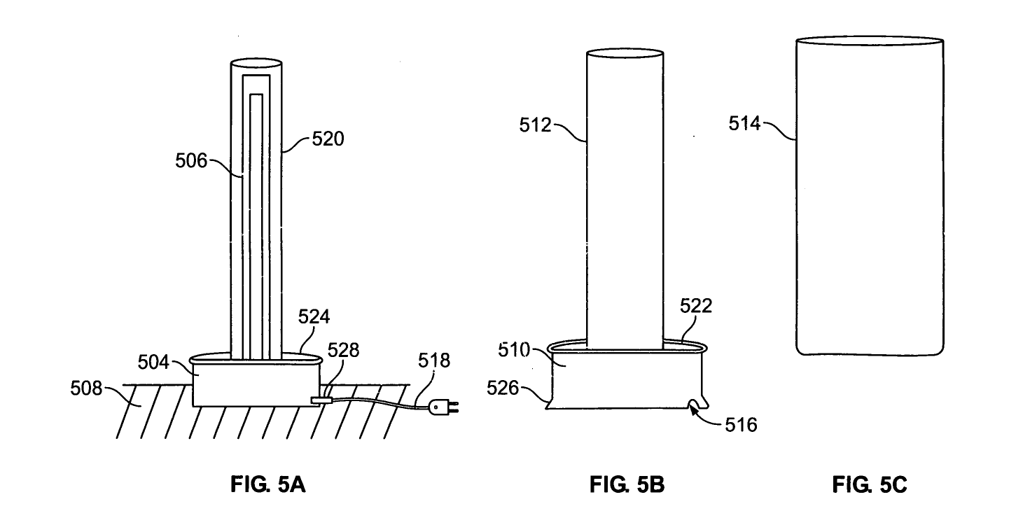

The present invention also contemplates other embodiments in which light sources and/or shields are vertically oriented. Referring to FIGS. 5a-c, in still another embodiment, the first element (shown in FIG. 5a) includes a base 504 that supports a vertically-oriented light source 506 and that rests on a support surface 508, such as a table. The second element (shown by FIGS. 5b-c) includes at least one shield that envelopes the entire first element and which is supported by a base 510 that rests on the support surface 508 so that it surrounds the base 504 of the first element without touching the base 504 or the first element. Preferably, the second element includes inner 512 and outer 514 cylinders that envelop the light source 506 without touching the light source 506 and interlock on the base 510 that rests on the support surface 508 in surrounding relation to the base 504 of the first element without touching the base 504 or the first element. The base 510 of the second element preferably has an opening 516 for a cord 518 that supplies electricity to the light source 506 (in portable embodiments, where batteries are used for power, such an opening is not necessary). The inner cylinder 512 is translucent (or transparent), and the outer cylinder 514 is opaque. When illumination is desired, the outer cylinder 514 can be removed so that only the inner cylinder 512 covers the light source 506. The inner cylinder 512 can be translucent to reduce glare from the light source 506. Alternatively, the inner cylinder 512 can be transparent, and the first element can include a translucent covering 520 over the light source 506 for glare reduction. It should be understood that such glare reduction features are merely optional in all of the embodiments described herein and the present invention encompasses embodiments where such glare reduction features are not present.

When darkness is desired, the outer cylinder 514 can be lowered over the inner cylinder 512 and fixed into a slot 522 in the base 510 of the second element, so that it is concentric with the inner cylinder 512 and completely covers the inner cylinder 512. In this manner, the light can be restricted without contact being made between the shields 512,514 and the light source 506, and without turning off the light source 506. Optionally, shading baffles 524 around the top of the base 504 of the first element, skirtings 526 around the bottom of the base 510 of the second element, and shields 528 around the electric cord 518 (if any), can be used to further ensure that light leakage is prevented. The skirtings 526 can be a flexible material such as rubber, cloth, or the like. The outer cylinder 514 can be removed and replaced as desired to restrict or allow the light to escape, without turning the light on or off, and without causing physical contact with the light source.

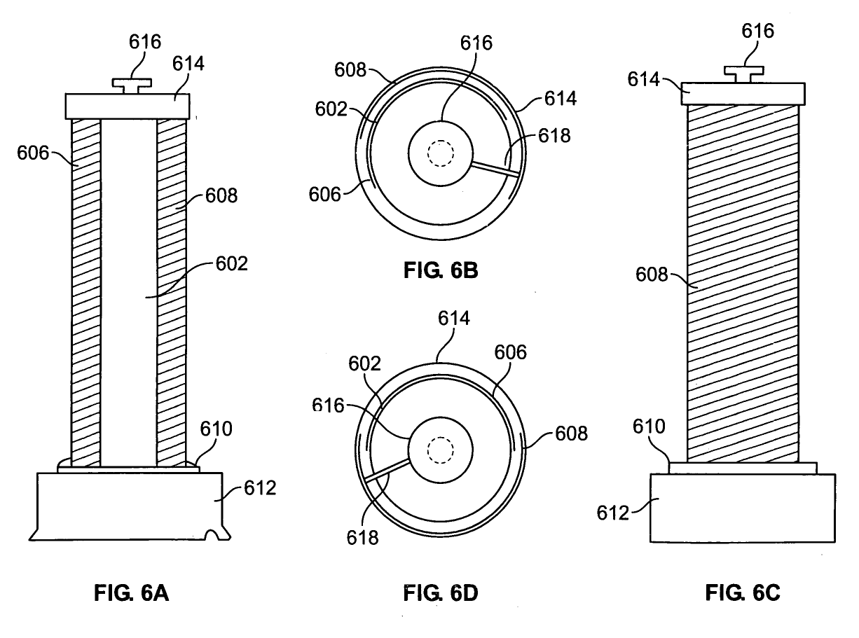

Referring to FIGS. 6a-d, in still another embodiment, the first element (the example shown in FIG. 5a is suitable for use with this embodiment) supporting the vertically oriented light source can be enveloped by a second element (shown in FIGS. 6a-d) that includes an inner translucent (or transparent) cylinder 602 and an outer cylinder, the outer cylinder being defined by at least one fixed opaque semi-cylindrical panel 606 and at least one movable opaque semi-cylindrical panel 608 (alternatively, an opaque section of a cylinder may be employed in lieu of panels). The movable panel 608 travels within a circumferential track 610 in the base 612 of the second element, the circumferential track 610 being formed radially inward (or outward, if desired) from the bottom of the fixed panel 606. Therefore, the movable panel 608 can be placed adjacent the fixed panel 606, as shown in FIGS. 6a-b, to allow a portion of the inner cylinder 602 to be exposed, thereby allowing light from the light source (not shown) to escape. The movable panel 608 can also be placed opposite the fixed panel 606, as shown in FIGS. 6c-d, to cause the inner cylinder 602 to be complete enclosed by the panels 606,608, thereby preventing light from the light source (not shown) from escaping. Preferably, in this position, the panels 606,608 at least slightly overlap to ensure that light leakage is prevented. It should be understood that positions of the movable panel other than these two positions can be used to vary the amount of light that is released. Therefore, the second element can be lowered over the first element without touching the first element or the light source, and the movable panel 608 can be moved as desired to restrict the light or allow the light to escape, without turning the light on or off and without causing physical contact with the light source.

To further ensure that light leakage is prevented when the inner cylinder 602 is completely enclosed, the top of the inner cylinder can be covered by an opaque circular cap 614.

The position of the panels 606,608 can be tailored to the particular surroundings in which the embodiment of the invention will be used. For example, if the embodiment is adjacent a wall of a room, the fixed panel can be facing the wall, and the movable panel can be moved to allow light to project into the room rather than toward the wall. Or, for example, an opposite arrangement can be provided if indirect lighting of the room is desired. The movement of the panels can be effected in any suitable manner.

Preferably, at least one control knob 616, mechanically attached to the movable panel 608, is provided that can be gripped by a user to move the panel 608. Preferably, this knob 616 is disposed on top of the cap 614 and is mechanically connected to a rod 618 within the cap that attaches to the movable panel 608 or cylinder). If desired, a slot (not shown) with appropriate light baffling features can be provided in the fixed panel 606 to accommodate the rod 618 (and/or the parts attaching the knob 616 to the movable panel 608) as the movable panel 608 is moved through a certain range of positions in which the fixed panel 606 would otherwise block the rod 618 to prevent movement of the movable panel 608.

It should be understood that instead of a fixed panel and a movable panel, other embodiments may have two movable opaque panels that can be moved relative to one another to be placed in positions completely enclosing the inner cylinder, and positions exposing the inner cylinder. It should also be understood that more than two panels can be used to effect the described functionality, and that the use of two panels discussed herein is merely one way to achieve that functionality.

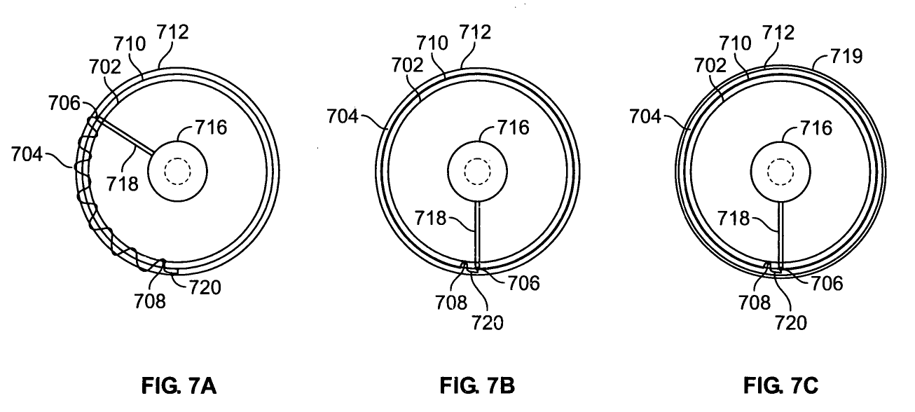

Referring to FIGS. 7a-b, in still another embodiment, instead of a solid outer cylinder or fixed and/or movable panels of an outer cylinder providing for selective shielding of the light source, a sliding folding door 704 is used to block the light from the light source. More particularly, the first element (the example shown in FIG. 5a is suitable for use with this embodiment) supporting the vertically oriented light source can be enveloped by a second element (shown in top views in FIGS. 7a-b) that includes an inner translucent (or transparent) cylinder 702 and an outer cylinder, the outer cylinder being defined by an opaque folding door 704 that can be opened and closed about the inner cylinder 702. The door 704 can be formed from any suitable flexible material, but preferably includes a flexible, opaque fabric with properties such that it will become flat when stretched, but will return to its folded position when contracted.

While any suitable manner of attaching the ends of the door 704 and effecting the opening and closing of the door 704 about the inner cylinder 702 can be used, in the illustrated embodiment one end 706 of the door 704 is fixed to the inner cylinder 702, and another end 708 travels in a track 710 in a base 712 of the second element and a corresponding track (not shown) in the cap of the second element. A knob 716 on the cap, attached to the one end 706 of the door 704 by a rod 718, can be rotated to cause the one end 706 to travel within the tracks to bring it toward the other end 708.

When the knob 716 is rotated clockwise, the ends 706,708 are brought together as shown in FIG. 7b and can be locked in this position with a connection shield 720. The connection shield is preferably opaque to prevent light leakage. At this maximum extension, the door 704 is completely unfolded and encompasses the inner cylinder 702 to completely block the light from the light source (not shown). When the knob 716 is rotated counter-clockwise, the ends 706,708 are moved apart as shown in FIG. 7a. The door 704 is then folded and allows at least a portion of the light to escape. It should be understood that the ends 706,708 can be placed in any position in between the positions shown in FIGS. 7a and 7b, to selectively vary the amount of light that escapes. It should also be understood that in some embodiments, the rotation can be reversed, so that clockwise rotation of the knob 716 closes the door 704, and counter-clockwise rotation of the knob 716 opens the door 704. FIG. 7c illustrates an embodiment of the present invention showing a second, translucent, outer cylinder 719 enclosing the folding door 704 and the movement mechanism in between the inner cylinder 702 and the second outer cylinder 719, to protect the door 704 and/or the mechanism from dirt and/or damage, and/or for aesthetic or other reasons and/or provide additional conformance to religious requirements, inasmuch as the strictest interpretations of relevant Jewish law require that the opening and closing of enclosing elements be minimized or avoided.

It should be understood that the present invention contemplates wall-mounted embodiments, in which, for example, one or more of the bases of a particular embodiment, as applicable, are mounted on a bedroom wall, living room wall, or other wall. It may be particularly desirable to mount an embodiment on the wall above a couch or a headboard. It should be understood that weights and dimensions of the material and elements of the embodiments described above can be changed, added, and/or subtracted to enable such mountings.

It should be further understood that the present invention contemplates easily portable embodiments. For example, such models could feature battery-powered operation and other features common to portable devices.

It should also be understood that while the use of concentric cylinder and domes are described, the present invention encompasses embodiments in which concentric cone-shaped elements are used. Moreover, the substitution of cylinder, domes and cones and other geometric shapes for others in the described or discussed embodiments should be understood to create other embodiments contemplated by the present invention.

Finally, it shall be understood that in alternative embodiments, or subtle but obvious modifications of the present invention, the translucent portions may be fully transparent and the opaque portions may be incompletely opaque. For example, some of these portions may be semi-opaque, polarized glass, colored glass, or other form of glass which interrupts the complete transmission of the light from within the device. Various designs, shapes, and geometric orientations of the opaque and translucent regions are also contemplated, but are viewed simply as artistic variations of the same principles which are embodied in this invention.

While there has been described and illustrated specific embodiments of new and novel illumination devices for use by religiously observant Jews, it will be apparent to those skilled in the art that variations and modifications are possible without deviating from the broad spirit and principle of the present invention.

1-20. (canceled)

21. An illumination device comprising:
a base for at least one electrical light source; an opaque top; and inner and outer members disposed between at least a portion of each of the base and top, the inner and outer members at least partially surrounding a location for at least one light source, the inner and outer members being at least partially opaque,
wherein the device is adapted to allow light to shine from itself with the inner and outer members in one configuration, and wherein the device is adapted to prevent light from shining from itself with at least one of the inner and outer members rotated into another configuration.

22. The device of claim 21, further comprising the light source.

23. The device of claim 22, wherein the light source comprises at least one fluorescent bulb.

24. The device of claim 21, wherein at least one of the inner and outer members comprises a panel.

25. The device of claim 24, wherein at least one panel is semi-cylindrical.

26. The device of claim 21, wherein the outer member comprises a hollow cylinder.

27. The device of claim 26, wherein the inner member comprises a hollow cylinder.

28. The device of claim 27, wherein a portion of each of the inner and outer members is translucent.

29. The device of claim 28, wherein the translucent portions are transparent.

30. The device of claim 21, wherein only one of the inner and outer members is rotatable relative to the base.

31. The device of claim 21, where in the top comprises a cap and the device further comprises a knob passing through the cap to rotate one of the inner and outer members.

32. A method of light control during religious observance, the method comprising:
providing a device as described in claim 22;
turning on the at least one electrical light source;
configuring the device to allow light to shine from the device; and
configuring the device so substantially no light shines from the device, without cutting power to the at least one light source.
